(19) United States
(12) Patent Application Publication
(10) Pub. No.: US 2015/0064441 A1
(43) Pub. Date: Mar. 5, 2015

(54) Isocyanate Functional Adhesive Useful for Headliner Assembly

(71) Applicant: Rohm and Haas Company, Philadelphia, PA (US)

(72) Inventor: Dario Monolo, Busto Arsizio (IT)

(21) Appl. No.: 14/534,602

(22) Filed: Nov. 6, 2014

Related U.S. Application Data
(63) Continuation of application No. PCT/IT12/00135, filed on May 9, 2012.

(51) Int. Cl. C09J 175/08; B60R 13/02; B32B 37/12; C09J 11/06; C08K 5/04

(52) U.S. Cl. CPC C09J 175/08; C09J 11/06; C08K 5/04; B32B 37/12; B60R 13/0212; B32B 2037/1253
USPC 428/317.7; 524/288; 156/305

(57) ABSTRACT

The present invention relates to a composition comprising: a) one or more prepolymers comprising the reaction product of a polyisocyanate having functionality of greater than 2 to about 2.9 and one or more polypropylene diols ethylene oxide capped polypropylene diols having a number average molecular weight of about 400 to 4,000; b) one or more polyisocyanates having a functionality of greater than 2 to about 2.9; c) one or more acids; d) one or more catalysts comprising dimethyl tin dicarboxylates, and e) one or more aromatic carbonyl chlorides. The composition can be used to bond laminates together useful in automobiles as for instance as headliners, in sunroofs and as rear shelves.

### FIELD OF THE INVENTION

The invention relates to isocyanate functional adhesive compositions useful for assembling automotive headliners. The present invention also relates to methods for assembling automotive headliners and for preparing the isocyanate functional adhesive compositions.

### BACKGROUND OF THE INVENTION

Automobiles typically have structures called headliners attached to and covering the inside surface of the roof. Headliners perform one or more of the following functions: cover the underside of the roof in a decorative manner; provide a surface that absorbs impact when an object or occupant in the vehicle contacts the roof; provide some insulation against temperature differentials between the interior of the automobile and the exterior of the vehicle; and absorb sound generated within the interior cabin of the vehicle. Many headliners comprise a number of layers with different functions. One common layer is foam sheet which may function to absorb energy, absorb sound and/or insulate the interior from temperature differences between the interior and exterior of the automobile. In many cases the foam sheet is in essence the core of the headliner. Many headliners comprise a reinforcing layer disposed on one or both surfaces of the foam sheet. The reinforcing layer can be a layer of fibers or a coherent sheet prepared from fibers, such as a fiberglass mat. A backing layer may be located adjacent to one or both of the reinforcing layers so as to cover and/or contain the reinforcing layer. A decorative layer facing the interior of the vehicle may be adjacent to the backing layer or the reinforcing layer. The foam sheet can be bonded to the reinforcing layer and in some embodiments to the backing layer using a low viscosity adhesive. Some known adhesives are isocyanate functional compositions. Some of the other layers may be bonded together using adhesive films such as ethylene acrylic acid and ethylene vinyl acetate containing films. Exemplary headliner systems and adhesives are disclosed in Romesberg et al. U.S. Pat. Nos. 5,582,906 and 5,486,256 both incorporated herein by reference in their entirety. An exemplary commercial isocyanate functional adhesive used in the structures is MOR-AD 460 LC adhesive system, available from Dow Chemical, Midland, Mich.

Some known adhesive systems utilized in assembling headliners contain volatile organic compounds. There is significant pressure to reduce the amount of volatile organic compounds in such adhesives or remove volatile organic compounds from such adhesives. In addition some isocyanate functional formulations contain dibutyl tin dialkylate catalysts. There have been recent regulatory concerns with respect to the presence of such compounds in isocyanate functional systems. Thus it is desirable to provide isocyanate functional systems, such as adhesives which address these concerns.

Thus, what is needed are isocyanate functional adhesive compositions which contain no or low levels of volatile organic compounds and which do not contain dibutyl tin dialkylate catalysts. What is further needed are headliner systems and methods for preparing headliners using such adhesives. Also needed are methods of preparing such adhesive systems.

### SUMMARY OF THE INVENTION

The present invention relates to a composition comprising: a) one or more prepolymers comprising the reaction product of a polyisocyanate having a functionality of greater than 2 to about 2.9 and one or more polypropylene diols or ethylene oxide capped polypropylene diols having a number average molecular weight of about 400 to 4,000; b) one or more polyisocyanates having a functionality of greater than 2 to about 2.9; c) an acid capable of adjusting the reactivity of isocyanate containing compounds; d) one or more catalysts selected from the group of dimethyl tin dicarboxylates; and e) one or more aromatic carbonyl chlorides. The prepolymer may further comprise one or more monofunctional polypropylene oxides or ethylene oxide capped polypropylene oxides having a number average molecular weight of about 300 to about 1000.

In another embodiment, the invention is a method comprising: i) applying a composition according the invention to one or both faces of a foam sheet; ii) contacting a layer of reinforcing material with the one or both faces of the foam sheet having the composition applied thereto; iii) contacting decorative sheet to the reinforcing material; iv) applying pressure to the outside surface of the decorative sheet under conditions such that the composition cures and bonds the foam sheet, reinforcing material and decorative sheet together. In a preferred embodiment, water is applied to the foam sheet with the composition applied thereto before the reinforcing layer is contacted with the foam sheet.

In another embodiment, the invention is a method comprising: i) contacting one or more polyisocyanates having a functionality of greater than 2 to about 2.9 and one or more polypropylene diols or ethylene oxide capped polypropylene diols having a number average molecular weight of about 400 to 4,000; ii) heating the one or more prepolymers comprising the reaction product of a polyisocyanate having a functionality of greater than 2 to about 2.9 and one or more polypropylene diols or ethylene oxide capped polypropylene diols having a number average molecular weight of about 400 to 4,000 to a temperature at which an isocyanate functional prepolymer is formed for a sufficient time such that a mixture having an isocyanate content of about 10 to about 22 percent by weight is prepared; iii) contacting the reaction product of step ii with an acid capable of adjusting the reactivity of isocyanate containing compounds and mixing for a sufficient time to form a homogeneous mixture; iv) cooling or allowing the mixture to cool and adding an additional amount of polyisocyanate having a functionality of greater than 2 to about 2.9 and a catalyst selected from the group of dimethyl dialkylates; v) cooling or allowing the mixture of step iv to cool to less than 55° C. and contacting an aromatic carbonyl chloride with the mixture of step iv and mixing for a sufficient time to form a homogeneous mixture. In a preferred embodiment, gels and large particles are removed from the mixture after step v).

In another embodiment, the invention is an article comprising: i) a foam sheet having two opposing faces; ii) reinforcing layers adjacent to one or both of the faces of the foam sheet; iii) a backing layer or decorative layer adjacent to the reinforcing layers; wherein the foam sheet is bonded to the reinforcing layers by an isocyanate functional composition as described hereinbefore; wherein the article is useful as a headliner in a vehicle having an interior cabin. One of the backing layers may be located adjacent to each of the reinforcing layers. The decorative layer may be disposed adjacent to the backing layers adapted to be disposed facing the interior cabin of the automobile.

The compositions of the invention provide adhesives which have low or no volatile organic compounds and exhibit a low fog contribution when utilized in an automobile. The compositions of the invention provide adhesives which further avoid the use of dibutyl tin dicarboxylates, such as dibutyl tin dilaurate. The invention provides headliners and methods for preparing headliners wherein the volatile organic content contributed by the adhesive utilized is eliminated or reduced and the use of dibutyl tin dicarboxylates is eliminated. The invention provides a method for preparing compositions which provide adhesives that demonstrate these advantages. The composition can be used to bond laminates together useful in automobiles, for instance as headliners, in sunroofs and as rear shelves (package trays),

### DESCRIPTION OF THE DRAWINGS

FIG. 1 is a cross sectional view of a headliner of the invention.

FIG. 2 is a cross sectional view of a second headliner of the invention.

FIG. 3 is an exploded cross sectional view of a third headliner of the invention.

FIG. 4 is a schematic of a process for preparing headliners of the invention.

### DETAILED DESCRIPTION

The explanations and illustrations presented herein are intended to acquaint others skilled in the art with the invention, its principles, and its practical application. The specific embodiments of the present invention as set forth are not intended as being exhaustive or limiting of the invention. The scope of the invention should be determined not with reference to the above description, but with reference to the appended claims, along with the full scope of equivalents to which such claims are entitled. The disclosures of all articles and references, including patent applications and publications, are incorporated by reference for all purposes. Other combinations are possible as will be gleaned from the following claims, which are also hereby incorporated by reference into this written description,

One or more as used herein means that at least one, or more than one, of the recited components may be used as disclosed. Nominal as used with respect to functionality means the theoretical functionality, generally this can be calculated from the stoichiometry of the ingredients used. Generally, the actual functionality is different due to imperfections in raw materials, incomplete conversion of the reactants and formation of by-products. Isocyanate content means the weight percent of isocyanate groups in the designated component, such as prepolymer. The isocyanate content can be measured by analytical techniques known to one skilled in the art, for example by potentiometric titration with an active hydrogen containing compound, such as dibutyl amine. Residual content of a component refers to the amount of the component present in free form or reacted with another material, such as a prepolymer. The residual content of a component can be calculated from the ingredients utilized to prepare the component or composition. Alternatively, it can be determined utilizing known analytical techniques. As used herein percent by weight or parts by weight refer to, or are based on, the weight or the components or compositions recited unless otherwise specified. The term isocyanate-reactive compound as used herein includes any organic compound having nominally at least two isocyanate-reactive moieties. For the purposes of this invention, an isocyanate reactive moiety, an active hydrogen containing moiety, refers to a moiety containing a hydrogen atom which, because of its position in the molecule, displays significant activity according to the Zerewitinoff test described by Wohler in the Journal of the American Chemical Society, Vol. 49, p. 3181 (1927), illustrative of such isocyanate reactive moieties, such as active hydrogen moieties, are —COOH, —OH, —NH₂, —NH—, —CONH₂, —SH, and —CONH—. Preferable isocyanate reactive moiety containing compounds, active hydrogen containing compounds, include polyols, polyamines, polymercaptans and polyacids. More preferably, the isocyanate reactive compounds include polyols, and even more preferably polyether polyols. Substantially all means about 99 percent by weight or greater of the referenced material, and more preferably 99.9 percent by weight or greater.

The invention relates to a composition useful as an adhesive. The adhesive can be used to bond a variety of substrates together, in one preferred embodiment the adhesive is utilized to bond components of a headliner useful in a vehicle, for example an automobile, together. The composition comprises a) one or more prepolymers comprising the reaction product of a polyisocyanate having a functionality of greater than 2 to about 2.9 and one or more polypropylene diols or ethylene oxide capped polypropylene diols having a number average molecular weight of about 400 to 4,000; b) one or more polyisocyanates having a functionality of greater than 2 to about 2.9; c) an acid capable of adjusting the reactivity of isocyanate containing compounds; d) one or more catalysts selected from the group of dimethyl tin dicarboxylates; and e) one or more aromatic carbonyl chlorides.

The compositions may further comprise any one or more of the features described in this specification in any combination, including the preferences and examples listed in this specification, and includes the following features: the prepolymer further comprises one or more monofunctional polypropylene oxides or ethylene oxide capped polypropylene oxides having a number average molecular weight of about 300 to about 1000 which are capable of adjusting the reactivity of isocyanate containing compounds; the composition comprises; a) from about 20 to about 90 percent by weight of one or more polyisocyanate prepolymers and b) one or more polyisocyanates; c) from about 0.045 to about 0.07 percent by weight of an acid; d) from about 0.02 to about 0.10 percent by weight of one or more catalysts; and e) from about 0.02 to about 0.07 percent by weight of one or more aromatic carbonyl chlorides; the composition comprises about 25 to about 35 weight percent of one or more polypropylene diols or ethylene oxide capped polypropylene diols or the residue thereof; the composition comprises from about 65 to about 75 percent by weight of the residue of one or more polyisocyanates and one or more polyisocyanates; one or more monofunctional polypropylene oxides or ethylene oxide capped polypropylene oxides are present in an amount of greater than 0 to about 5.5 percent by weight; the composition exhibits a viscosity of about 500 to about 8000 MPa·s; the composition exhibits an isocyanate content of about 15 to about 23 percent by weight; the catalyst comprises dimethyl tin dilaurate; the aromatic carbonyl chloride is benzoyl chloride or phthaloyl chloride; and exhibits a fog of about 250 ppm or less.

The articles of the invention may further comprise any one or more of the features described in this specification in any combination, including the preferences and examples listed in this specification, and includes the following features; one of the reinforcing layers is located adjacent to each of the faces of the foam sheet; one of the backing layers is located adjacent to each of the reinforcing layers; and the decorative layer is disposed adjacent to the backing layers adapted to be disposed facing the interior cabin of the automobile.

The method for preparing a headliner may further comprise any one or more of the features described in this specification in any combination, including the preferences and examples listed in this specification, and includes the following features: water is applied to the foam sheet with the composition applied thereto before the reinforcing sheet is contacted with the foam sheet; reinforcing material and decorative sheets are applied to both faces of the foam sheet; the reinforcing sheets comprise fiberglass; the decorative sheet is a textile; the composition is applied by a roll coating; wherein water is applied by spraying; the composition is applied at an amount of about 40 g/M² to about 45 g/M²; water is applied at an amount of about 15 g/M² to about 20 g/M²; the pressure applied is from about 60 MPa to about 150 MPa; the foam sheet with the composition, reinforcing material and decorative sheet applied thereto is heated from about 125° C. to about 140° C. while pressure is applied; pressure and heat are applied for about 20 to about 40 seconds; and the foam sheet is a semirigid polyurethane or polyurea based foam sheet.

The method for preparing an adhesive composition may further comprise any one or more of the features described in this specification in any combination, including the preferences and examples listed in this specification, and includes the following features: gels and large particles are removed from the mixture; the large particles and gels are removed by passing the mixture of step v through a sieve or screen having openings from about 200 microns to about 250 microns; the final mixture is packaged in moisture proof containers; heating the one or more prepolymers comprising the reaction product of a polyisocyanate having a functionality of greater than 2 to about 2.9 and one or more polypropylene diols or ethylene oxide capped polypropylene diols having a number average molecular weight of about 400 to about 4,000 to a temperature of about 75 to about 80° C.; heating the one or more prepolymers comprising the reaction product of a polyisocyanate having a functionality of greater than 2 to about 2.9 and one or more polypropylene diols or ethylene oxide capped polypropylene diols having a number average molecular weight of about 400 to 4,000 for about 1 to about 2 hours; the mixture is mixed for about 15 to about 30 minutes after the addition of acid; the mixture is mixed for about 15 to about 30 minutes after the addition of acid; and the mixture is mixed for about 15 to about 30 minutes after the addition of aromatic carbonyl chloride.

The compositions comprise one or more prepolymers comprising the reaction product of a polyisocyanate having a functionality of greater than 2 to about 2.9 and one or more polypropylene diols or ethylene oxide capped polypropylene diols having a number average molecular weight of about 400 to 4,000. The prepolymers may be prepared as described hereinafter. The polyisocyanate can be any polyisocyanate having a functionality of greater than 10 to about 2.9. The polyisocyanate can be any oligomeric or addition product of a di or polyisocyanate having the specified functionality. The di or polyisocyanate can be aliphatic, aromatic or mixtures thereof. Preferably the polyisocyanates are aromatic. Preferably the polyisocyanates are oligomers or polymers of methylene diphenyl diisocyanate. Exemplary oligomers of methylene diphenyl diisocyanate include PAPI 20 and PAPI 27 oligomeric methylene diphenyl diisocyanates, available from Dow Chemical, Midland Mich. Exemplary polymers of methylene diphenyl diisocyanate include Voranate M220 polymeric methylene diphenyl diisocyanate, available from Dow Chemical, Midland Mich. The polyisocyanates preferably exhibit a functionality of about 2 or greater and more preferably about 2.5 or greater. The polyisocyanates preferably exhibit a functionality of about 2.8 or less and more preferably about 2.7 or less. The one or more polyisocyanates are present in sufficient amount to fully react with the diols and optional monols such that substantially all of the hydroxyl groups from the diols and monols are reacted and the composition exhibits the desired isocyanate content. In the polyisocyanates may be added in one portion before reaction with the diol and optional monol or in two portions with a second portion added after the prepolymer is prepared. The composition further contains one or more polyisocyanates in the unreacted form. A portion of the one or more polyisocyanates is present in the composition as residue in the prepolymer. The one or more polyisocyanates are present in the composition, individually and as part of the prepolymer, in an amount of about 40 percent by weight or greater and most preferably about 65 percent by weight or greater based on the weight of the composition. The one or more polyisocyanates are present in the composition, individually and as part of the prepolymer, in an amount of about 90 percent by weight or less and most preferably about 75 percent by weight or less based on the weight of the composition.

The one or more prepolymers, including the polyisocyanates, are present in sufficient amount to provide the desired viscosity and to impact the adhesive and cohesive strength of the composition. Preferably, the prepolymers, including the polyisocyanates, are present in an amount of about 20 percent by weight or greater based on the weight of the composition, more preferably about 50 percent by weight or greater and most preferably about 60 percent by weight or greater. Preferably, the one or more prepolymers, including the polyisocyanates, are present in an amount of about 90 percent by weight or less based on the weight of the composition and most preferably about 75 percent by weight or less.

The compositions used to prepare the prepolymer comprise one or more polypropylene oxide or ethylene oxide capped polypropylene oxide diols. Any polypropylene oxide or ethylene oxide capped polypropylene oxide diols that provide the desired viscosity and flexibility of the prepolymer may be used. Preferably the diols are polypropylene oxide diols. The diols preferably exhibit a number average molecular weight such that the diols provide the desired viscosity and flexibility of the prepolymer. The number average molecular weight of the diols is preferably about 200 or greater and most preferably about 400 or greater. The number average molecular weight of the diols is preferably about 4000 or less. The one or more diols are present in sufficient amount to provide the desired viscosity and flexibility of the prepolymer. The diols can be present individually or as a residue in the prepolymers and preferably as a residue in the prepolymer. Preferably, the diols are present in an amount of about 10 percent by weight or greater based on the weight of the composition, and most preferably about 25 percent by weight or greater. Preferably, the diols are present in an amount of about 50 percent by weight or less based on the weight of the composition and most preferably about 35 percent by weight or less. Exemplary diols useful are Voranol 2000L diol from Dow Chemical, Midland Mich.

The compositions may further comprise one or more monofunctional polypropylene oxides or ethylene oxide capped polypropylene oxides, monols. The monols are present for the purpose of reducing the isocyanate content of the polymer and the viscosity of the prepolymer. Exemplary monols comprise monofunctional polypropylene oxides or ethylene oxide capped polypropylene oxides include Breox MPEG 500 mortal of Clariant. The one or more monofunctional polypropylene oxides or ethylene oxide capped polypropylene oxides are present in sufficient amount to reduce the viscosity and isocyanate content of the prepolymer. Preferably, the one or more monofunctional polypropylene oxides or ethylene oxide capped polypropylene oxides are present in an amount of about 0 percent by weight or greater based on the weight of the composition, more preferably about 5 percent by weight or greater and most preferably about 7 percent by weight or greater. Preferably, the one or more monofunctional polypropylene oxides or ethylene oxide capped polypropylene oxides are present in an amount of about 10 percent by weight or less based on the weight of the composition, more preferably about 6 percent by weight or less and most preferably about 5.5 percent by weight or less. Preferred are the monofunctional polypropylene oxides. The monols are added prior to preparing the prepolymer and reacted into the prepolymer in the final composition; they are present in the final composition as residue.

The compositions further comprise one or more catalysts comprising a dimethyl tin dicarboxylate. Exemplary catalysts include dimethyl tin dilaurate. The one or more catalysts are present in sufficient amount to provide the desired reaction rate. Preferably, the one or more catalysts are present in an amount of about 0.2 percent by weight or greater based on the weight of the composition, more preferably about 0.10 percent by weight or greater and most preferably about 0.15 percent by weight or greater. Preferably, the one or more catalysts are present in an amount of about 0.3 percent by weight or less based on the weight of the composition, more preferably about 0.20 percent by weight or less and most preferably about 0.18 percent by weight or less.

The compositions further comprise an acid capable of adjusting the reactivity of isocyanate group containing compounds and enhancing the cure of the composition. Any acid that is capable of adjusting the reactivity of isocyanate group containing compounds and enhancing the cure of the composition may be used in the composition. Exemplary acids include carboxylic acids, sulfuric acid and phosphoric acid. The acid is present in sufficient amount to adjust the reactivity of isocyanate group containing compounds and enhance the cure rate of the composition once applied. Preferably, acid is present in an amount of about 0.03 percent by weight or greater based on the weight of the composition, more preferably about 0.045 percent by weight or greater and most preferably about 0.05 percent by weight or greater. Preferably, the acid is present in an amount of about 0.0 percent by weight or less based on the weight of the composition, more preferably about 0.07 percent by weight or less and most preferably about 0.065 percent by weight or less.

The compositions may further comprise one or more aromatic carbonyl chlorides. Any aromatic carbonyl chloride containing one or more carbonyl and chloride groups adjacent to one another and bonded to an aromatic ring and which stabilize the composition before application to a substrate may be used. Stabilizes as used herein means that the composition does not cure significantly in storage. Preferably the composition does not exhibit a significant increase on viscosity over a period of 9 months while stored in a moisture proof container. Significant increase in viscosity means the composition is capable of being applied by spraying or roll coating oiler the storage period. Preferably, the aromatic carbonyl chlorides comprise one or more adjacent carbonyl and chloride groups bonded to a benzene ring. Exemplary aromatic carbonyl chlorides include benzoyl chloride and phthaloyl dichloride, and the like. The aromatic acid chlorides are present in sufficient amount to stabilize the composition before application to a substrate. Preferably, the aromatic carbonyl chlorides are present in an amount of about 0.01 percent by weight or greater based on the weight of the composition, more preferably about 0.02 percent by weight or greater and most preferably about 0.06 percent by weight or greater. Preferably, the aromatic carbonyl chlorides are present in an amount of about 0.08 percent by weight or less based on the weight of the composition, more preferably about 0.07 percent by weight or less and most preferably about 0.065 percent by weight or less.

The composition is generally prepared by the process comprising: i) contacting one or more polyisocyanates having a functionality of greater than 2 to about 2.9 and one or more polypropylene diols or ethylene oxide capped polypropylene diols having a number average molecular weight of about 400 to about 4,000; ii) heating the one or more polyisocyanates having a functionality of greater than 2 to about 2.9 and one or more polypropylene diols or ethylene oxide capped polypropylene diols having a number average molecular weight of about 400 to 4,000 to a temperature at which an isocyanate functional prepolymer is formed for a sufficient time such that a mixture having an isocyanate content of about 14 to about 20 percent by weight is prepared; iii) contacting the reaction product of step ii with an acid and mixing for a sufficient time to form a homogeneous mixture; iv) cooling or allowing the mixture to cool and adding an additional amount of polyisocyanate having a functionality of greater than 2 to about 2.9 and a catalyst selected from the group of dimethyl dialkylates; v) cooling or allowing the mixture of step iv to cool to less than 55° C. and contacting an aromatic acid chloride with the mixture of step iv and mixing for a sufficient time to form a homogeneous mixture. The one or more polyisocyanates, one or more polypropylene diols or ethylene oxide capped polypropylene diols and optionally one or more monofunctional polypropylene oxides or ethylene oxide capped polypropylene oxides are contacted in a reactor. A sufficient amount of polyisocyanate is included in this step such that the prepolymer formed has isocyanate functional groups. The one or more polyisocyanates are present in an equivalent excess as compared to the diol and optional monol. The upper limit on the amount of polyisocyanate is practicality in that if too much is added unnecessary costs are introduced due to excessive energy costs for heating the reaction mixture. Preferably the ratio of polyisocyanate equivalents to hydroxyl equivalents is about 10:1 or greater and most preferably about 18:1 or greater. Preferably the ratio of polyisocyanate equivalents to hydroxyl equivalents is about 20:1 or less and most preferably about 19:1 or less. The mixture is exposed to temperatures at which the reaction of isocyanate groups from the polyisocyanate with hydroxyl groups from the diol or mono proceeds at a reasonable rate. Preferably the mixture is heated. Preferably the mixture is exposed to a temperature of about 70° C. or greater and most preferably to a temperature of about 75° C. or greater. Preferably the mixture is exposed to a temperature of about 85° C. or less and most preferably to a temperature of about 80° C. or less. The mixture is preferably mixed during exposure to elevated temperature. The mixture is exposed to elevated temperatures for a sufficient time to react substantially all of the hydroxyl groups of the diols and monols with isocyanate groups of the polyisocyanates. Preferably the mixture is exposed to elevated temperatures for a time period of about 1 hour or greater and most preferably about 1.5 hour or greater. Preferably the mixture is exposed to elevated temperatures for a time period of about 2 hours or less and most preferably about 1.5 hours or less. The reaction is preferably monitored for the isocyanate content and is continued until the desired isocyanate content is achieved. Preferably the isocyanate content is about 14 percent by weight or greater and more preferably about 18 percent by weight or greater. Preferably the isocyanate content is about 20 percent by weight or less and more preferably about 19 percent by weight or less. The resulting product contains one or more isocyanate functional prepolymers and polyisocyanates. Once the desired isocyanate content is reached additional polyisocyanate is added with mixing to provide the desired isocyanate content as described herein.

Thereafter, the acid is added with mixing. The mixing is continued for a sufficient amount of time to disperse the acid throughout the mixture. Preferably the mixture containing the acid is mixed for a three period of about 15 minutes or greater and most preferably about 20 minutes or greater. Preferably the mixture is mixed for a time period of about 30 minutes or less and most preferably about 20 minutes or less. The mixing is preferably performed with continued exposure to elevated temperatures.

After mixing, the mixture containing the prepolymer, polyisocyanates and acid, the mixture is allowed to cool. During cooling an additional amount of polyisocyanate and catalyst are added with mixing. Preferably the isocyanate content of the mixture is about 15 percent by weight or greater and more preferably about 20 percent by weight or greater. Preferably the isocyanate content is about 23 percent by weight or less and more preferably about 22 percent by weight or less.

Once the temperature falls below about 55° C. one or more aromatic carbonyl chlorides are added with mixing. The mixture is then mixed for a sufficient time to disperse the aromatic carbonyl chlorides throughout. Preferably the mixture containing aromatic carbonyl chlorides is mixed for a time period of about 15 minutes or greater and most preferably about 20 minutes or greater. Preferably the mixture containing aromatic carbonyl chlorides is mixed for a time period of about 30 minutes or less and most preferably about 20 minutes or less. Thereafter the mixture can be removed from the reactor. Preferably the reactor is sealed to prevent moisture from entering the reactor. Preferably the reaction is performed under an inert gas or vacuum so as to prevent moisture from reacting with the isocyanate groups and curing the mixture. It is preferable to remove large particles or gels from the product. It is preferable to remove any particles of a size that may interfere with application of the composition to a substrate. For instance where the composition is applied by spraying, any particles that may plug the sprayer or nozzle should be removed. Preferably particle of 200 microns or greater are removed and more preferably about 250 microns or greater. The large particles and gels are preferably removed by passing the mixture through a sieve or screen having openings from about 200 microns to about 250 microns. The particles can be removed using any separation process that effectively removes particles of the desired size. Exemplary removal processes include passing the mixture through a sieve or screen of the desired size. The recovered composition is preferably packaged in moisture proof containers to prevent cure before application.

The compositions preferably exhibit a low viscosity. Preferably the viscosity selected such that composition can be applied by roll coating or spraying. The viscosity is preferably about 500 MPa·s or greater and most preferably about 1000 MPa·s or greater. Preferably the viscosity is about 8000 MPa·s or less, more preferably about 3000 MPa·s or less and most preferably about 2000 MPa·s or less.

The compositions may used as an adhesive. Preferably in applications that require low viscosity for application, for example where the adhesive is applied by spraying, roll coating, bead, rake, brush, and the like. Such applications include assembling headliners, sunroofs, rear shelves, industrial panels, package trays and the like.

In some preferred embodiments, the compositions can be utilized to assemble headliners. A process for assembling headliners utilizing the composition of the invention generally comprises: i) applying a composition of the invention to one or both faces of a foam sheet; ii) contacting a layer of reinforcing material with the one or both faces of the foam sheet having the composition applied thereto; iii) contacting decorative sheet to the reinforcing material; iv) applying pressure to the outside surface of the decorative sheet under conditions such that the composition cures and bonds the foam sheet, reinforcing material and decorative sheet together. In some embodiments a backing layer is bonded to one or both surfaces of the foam core with the reinforcing layer disposed between them. In some embodiments the adhesive of the invention, and optionally water, are applied to the surface of the backing layers or decorative layer adjacent to the reinforcing layer.

In preferred embodiments a headliner comprises a foam sheet core. The foam sheet comprises two opposing faces with edges about the periphery of the faces. The foam sheet has a thickness sufficient to achieve the desired functions of the headliner as described hereinbefore. The particular functions desired and thickness of the sheet varies depending on the design of the vehicle and the acceptable packaging space and cost for the particular vehicle the headliner is to be placed in. Headliners are custom designed for each vehicle. The foam can be based on thermoset polymers or thermoplastic polymers. Thermoset polymers include polyurethanes and epoxies. Thermoplastic materials include polyolefins and the like. Preferably, the foam sheet is a semirigid polyurethane or polyurea based foam sheet. Preferably the foam is a polyurethane based foam.

Headliners may further comprise one or more reinforcing layers. The reinforcing layers provide stiffness to the headliner. A reinforcing layer may be placed adjacent to one or both faces of the foam sheet. Preferably the reinforcing layer has pores or voids that allow the composition of the invention to flow through it when exposed to elevated temperatures. The composition may flow through the reinforcement layer to the backing layer and bond all three layers together. The reinforcing layer can be comprised of any material that provides stiffness and allows the compositions to penetrate and pass through it. Exemplary reinforcing layers include chopped fibers, such as glass, fiberglass mats, and the like. Chopped fiber reinforcing layer are described in U.S. Pat. No. 5,582,906 incorporated herein by reference, see for example Column 4 lines 43 to 55. The reinforcing layers are of sufficient thickness to provide the desired stiffness.

Adjacent to the reinforcement layers are backing layers. The backing layers function to cover the reinforcing layer or and in some embodiments to hold the reinforcement layer in place, such as where the reinforcing layer comprises chopped fibers. The backing layers comprise any material that can provide these functions. Preferably the backing layer is a fabric which may be woven or nonwoven, commonly referred to as scrim, or a mat of non-aligned fibers, commonly referred to as “reemay” (a form of nonwoven fiber layers). Preferably the backing layer has sufficient wetting properties to be wet by the composition of the invention such that the composition can bond the backing layer, reinforcing layer and foam sheet together. Preferably the fabric is cotton based. Preferably the mats are polyester based. The backing layer has a sufficient thickness to contain the reinforcing layer and to fit within the space allocated for the headliner. The backing layer may contain a foam layer on one side to prevent the shape of the fibers from showing through to the visible surface of the headliner. Preferably the foam layer is adjacent to the fibers.

Headliners preferably comprise a decorative layer that is disposed on the visible surface of the headliner once it is placed in an automobile. The decorative layer can be adjacent to a backing layer or it can be adjacent to the reinforcing layer and function as a backing layer. The decorative layer can have a foam on the nonvisible surface. In an alternative embodiment the backing layer, decorative layer and/or reinforcing layer can be bonded together using a separate adhesive or adhesive film, such as a film containing ethylene acrylic acid or ethylene vinyl acetate.

In preparing a headliner a composition of the invention is applied to one or both faces of the foam sheet and, optionally, to a face or surface of a backing layer or the back side of a decorative layer. The composition can be applied by any know method that is capable of applying the composition to a surface, such as brushing, rolling, spraying and the like. Preferably the composition is applied by roll coating or by spraying. The composition is applied in a sufficient amount to bond the foam sheet to the reinforcing layer and optionally to the backing layer or decorative layer. Preferably the composition is applied at a level of about 30 g/M² or greater, more preferably about 40 g/M² or greater and most preferably about 45 g/M² or greater. Preferably the composition is applied at a level of about 45 g/M² or less. The composition can cure by exposure to ambient atmospheric moisture, often referred to as moisture curing. The rate of cure for moisture cure adhesives varies with the ambient humidity level and the ambient temperature. Cure can be accelerated if the water is applied to the face of the foam sheet after the composition is applied. Water can be applied in any way which facilitates contact with the composition of the invention. Water can be applied by brush, roller, spraying and the like. Preferably water is sprayed on the composition. Preferably water is applied to the composition on the foam sheet at a level of about 10 g/M² or greater, more preferably about 15 g/M² or greater and most preferably about 19 g/M² or greater. Preferably water is applied to the composition on the foam sheet at a level of about 25 g/M² or less and most preferably about 20 g/M² or less. Thereafter one or more reinforcing layers are placed on one or both faces of the foam sheet. If the reinforcing layer is a coherent structure such as a fiberglass mat, and the like, it is placed adjacent to one of the faces of the foam sheet. If the reinforcing layer is a layer of chopped fibers, the chopped fibers are applied to one or both of the faces of the foam sheet, such as by spraying the fibers to the desired thickness. Thereafter either a backing layer or a decorative layer is placed adjacent to the reinforcing layer, the backing or decorative layer have a foam layer of one side, the foam layer is placed on the reinforcing layer side. In some embodiments the composition of the invention flows or wicks through the reinforcing layer to contact the backing layer during subsequent processing so as to bond the layers together. In another embodiment, a spray adhesive, a second layer of the composition of the invention, or an adhesive film is placed between the reinforcing layer and the backing or decorative layer to bond the two layers together. If a decorative layer is not adjacent to the reinforcing layer, a decorative layer is placed adjacent to the backing layer on the surface that will face the interior of the vehicle. An adhesive layer, a layer of the composition of the invention or an adhesive film is placed between the backing layer and the decorative layer to bond the layers together. Where the adhesive layer is moisture curing or the composition of the invention is used, water can be applied to accelerate cure as described hereinbefore. After assembling the layers the laminate structure formed is preferably placed into a press to adhere the layers together and optionally shape the assembled laminate structure to match the shape of the roof to which the laminate structure, headliner, will be applied to. Preferably the press applies pressure to the laminate structure. Sufficient pressure to form the laminate structure into the desired shape and to facilitate bonding of the layers together may be utilized. Preferably the pressure applied is about 60 bar (6 MPa) or greater, more preferably about 100 bar (10 MPa) or greater and most preferably about 200 bar (20 MPa) or greater. Preferably the pressure applied is about 250 bar (25 MPa) or less and most preferably about 150 bar (15 MPa) or less.

Preferably the laminate is exposed to elevated temperatures while in the press. The elevated temperature is chosen such that the curing of the adhesives or composition of the invention is enhanced, that is proceeds at the desired speed. In other words the cycle time of the part in the press is within desired time frames Preferably the laminate structure is exposed to a temperature of about 120° C. or greater and most preferably to a temperature of about 130° C. or greater. Preferably the laminate structure is exposed to a temperature of about 140° C. or less. Preferably the cycle time is 20 seconds or greater, more preferably 25 seconds or greater and most preferably 30 seconds or greater. Preferably the cycle time if 40 seconds or less.

Preferably, the compositions are formulated to provide an open time of at least about 40 minutes or greater more preferably about 50 minutes or greater. Preferably, the one part adhesive compositions of the invention are formulated to provide an open time of about 90 minutes or less and more preferably about 60 minutes or less. “Open time” is understood to mean the time after application of the composition to a first substrate until it can no longer adhere to a second substrate. The laminate can be removed from the press. Thereafter it can be transported to a point of assembly and bonded into a structure, such as an automobile. The laminate structures described can also be utilized as door panels, package trays, sun roof components and the like.

The composition of the invention is preferably substantially free of solvent, that is more preferably contains 1 percent by weight or less of solvent and most preferably about 0.1 percent by weight or less of solvent, an most preferably no solvent. Preferably the composition generates about 250 ppm of volatile organics or less and most preferably about 100 ppm of volatile organics or less. Preferably the adhesive generates about 250 ppm of fog or less and most preferably about 100 ppm of fog or less.

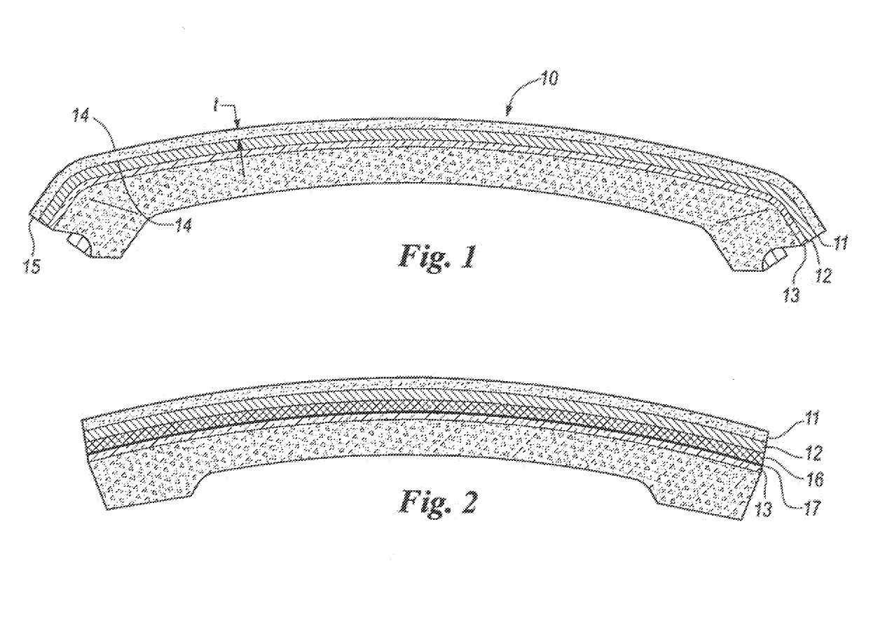

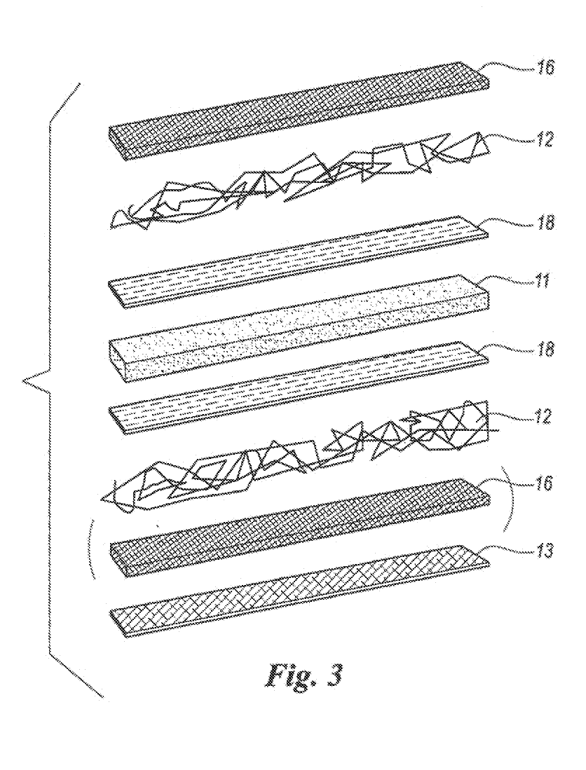

FIGS. 1 and 2 show cross sections of two headliners 10 that may be prepared by the methods of the invention using the compositions of the invention. FIG. 1 shows a foam core or layer 11 adjacent to a reinforcing layer 12 which is adjacent to a decorative layer 13. Also shown are the two opposing faces 14 of the foam core 11 and the edge 15 along the periphery of the foam core 11. FIG. 2 shows a foam core 11 adjacent to a reinforcing layer 12. A backing layer 16 is shown adjacent to the reinforcing layer 12. Adjacent to the backing layer is an adhesive film layer 17. The adhesive film layer 17 bonds the decorative layer 13 to the backing layer 16. In FIGS. 1 and 2 a discrete layer of the adhesive of invention is not shown as it is dispersed through the reinforcing layer and contacts both of the foam layer 11 and the backing layer 16 or decorative layer so as to bond the layers together.

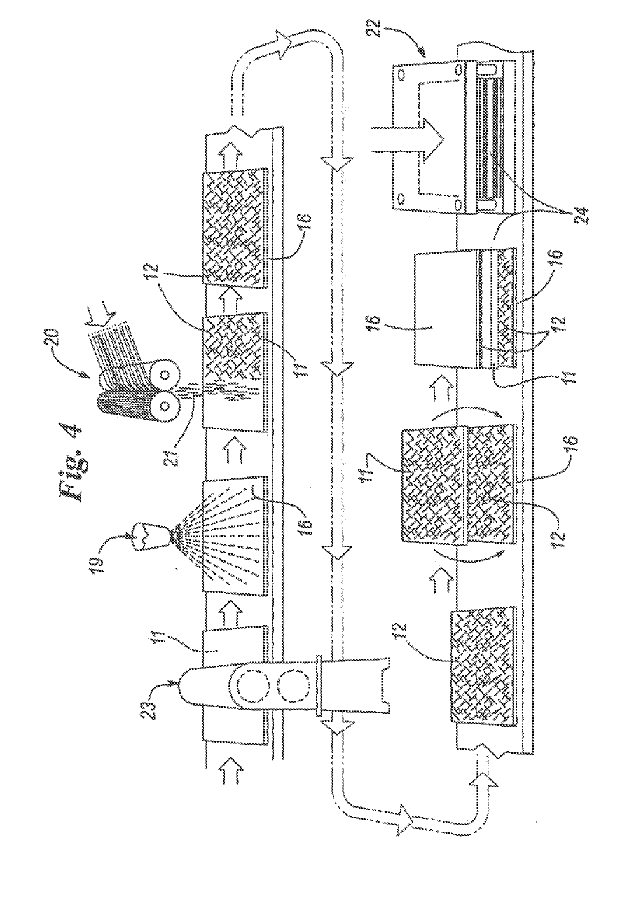

FIG. 3 shows another embodiment of a headliner of the invention along with the layers of adhesive of the invention in an exploded view. Shown is a foam core 11. Shown adjacent to the foam core 11 are two layers of adhesive of the invention 18. Adjacent to each adhesive layer 18 is a backing layer 16, barrier scrim. As assembled the adhesive 18 bonds the reinforcing layers 12, foam core layer 11 and backing layers 16 together. On the interior side of the structure is a decorative layer 13, textile. FIG. 4 illustrates a process for assembly of a headliner of the invention. The foam core layers 11 and backing layers 16 are passed through a roll coater 23 to apply adhesive to a surface of each. The foam core layers 11 and backing layers 16 are passed through a spray device 19 that sprays water onto the surface of the foam core layers 11 and the backing layers 16 having an adhesive coated deposited of the faces of each. The foam core layers 11 and backing layers are passed under roll cutters 21 that cut fiberglass fibers 20 into shorter fiber glass fibers 21A that are deposited on the foam core layers 11 and barrier layers 16 having the adhesive and water deposited on their surfaces. A composite structure 24 of a foam core layer 11 with reinforcing layers 12 on each surface 14 and backing layers 16 adjacent to the reinforcing layers 12. The composite structure 24 is placed in a heated press 22 to bond the layers of the composite structure 24 together.

Molecular weights as described herein are number average molecular weights which may be determined by Gel Permeation Chromatography (also referred to as GPC). For polyurethane prepolymers, it is also possible to calculate approximate number average molecular weight from the equivalent ratio of the isocyanate compounds and of the polyol compounds with which they are reacted as known to the persons skilled in the art.

Parts by weight as used herein refers to 100 parts by weight of the composition specifically referred to. Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. A composition comprising:
a) one or more polyisocyanate prepolymers comprising the reaction product of a polyisocyanate having a functionality of greater than 2 to about 2.9 and one or more polypropylene diols or ethylene oxide capped polypropylene diols having a number average molecular weight of about 400 to 4,000;
b) one or more polyisocyanates having a functionality of greater than 2 to about 2.9;
c) an acid capable of adjusting the reactivity of isocyanate containing compounds;
d) one or more catalysts selected from the group of dimethyl tin dicarboxylates; and
e) one or more aromatic carbonyl chlorides.

2. A composition according to claim 1 wherein the prepolymer further comprises one or more monofunctional polypropylene oxides or ethylene oxide capped polypropylene oxides having a number average molecular weight of about 300 to about 1000 capable of adjusting the reactivity of isocyanate containing compounds.

3. A composition according to claim 1 wherein the composition comprises:
a) from about 20 to about 90 percent by weight of one or more polyisocyanate prepolymers and b) one or more polyisocyanates;
c) from about 0.045 to about 0.07 percent by weight of acid;
d) from about 0.02 to about 0.10 percent by weight of one or more catalysts; and
e) from about 0.02 to about 0.07 percent by weight of one or more aromatic carbonyl chlorides.

4. A composition according to claim 3 wherein the composition comprises about 25 to about 35 weight percent of one or more polypropylene diols or ethylene oxide capped polypropylene diols or the residue thereof.

5. A composition according to claim 3 wherein the composition comprises from about 65 to about 75 percent by weight of the residue of one or more polyisocyanates and one or more polyisocyanates.

6. (canceled)

7. A composition according to claim 1 wherein the composition exhibits a viscosity of about 500 to about 8000 MPa·s.

8. A composition according to claim 1 wherein the composition exhibits an isocyanate content of about 15 to about 23 percent by weight.

9. A method comprising:
i) applying a composition according to claim 1 to one or both faces of a foam sheet;
ii) contacting a sheet of reinforcing material with the one or both faces of the foam sheet having the composition applied thereto;
iii) contacting decorative sheet to the reinforcing material; and
iv) applying pressure to the outside surface of the decorative sheet under conditions such that the composition cures and bonds the foam sheet, reinforcing material and decorative sheet together.

10. A method according to claim 9 wherein water is applied to the foam sheet with the composition applied thereto before the reinforcing sheet is contacted with the foam sheet.

11. A method according to claim 9 wherein the composition is applied by a roll coating.

12. A method according to claim 9 wherein water is applied by spraying.

13. A method according claim 9 wherein the composition is applied at an amount of about 40 g/M² to about 45 g/M².

14. A method according to claim 9 wherein water is applied at an amount of about 15 g/M² to about 20 g/M².

15. A headliner prepared according to the method of claim 9.

16. A method comprising:
i) contacting one or more prepolymers comprising the reaction product of a polyisocyanate having a functionality of greater than 2 to about 2.9 and one or more polypropylene diols or ethylene oxide capped polypropylene diols having a number average molecular weight of about 400 to 4000;
ii) heating the one or more prepolymers comprising the reaction product of a polyisocyanate having a functionality of greater than 2 to about 2.9 and one or more polypropylene diols or ethylene oxide capped polypropylene diols having a number average molecular weight of about 400 to 4000 to a temperature at which an isocyanate functional prepolymer is formed for a sufficient time such that a mixture having an isocyanate content of about 14 to about 20 percent by weight is prepared;
iii) contacting the reaction product of step ii with an acid and mixing for a sufficient time to form a homogeneous mixture;
iv) cooling or allowing the mixture to cool and adding an additional amount of polyisocyanate having a functionality of greater than 2 to about 2.9 and a catalyst selected from the group of dimethyl tin dicarboxylates; and
v) cooling or allowing the mixture of step iv to cool to less than 55° C. and contacting an aromatic carbonyl chloride with the mixture of step iv and mixing for a sufficient time to form a homogeneous mixture.

17. A method according to claim 16 wherein gels and large particles are removed from the mixture.

18. A method according to claim 17 wherein the large particles and gels are removed by passing the mixture of step v through a sieve or screen having openings from about 200 microns to about 250 microns.

19. An article comprising
i) a foam sheet having two opposing faces;
ii) reinforcing layers adjacent to one or both of the faces of the foam sheet;
iii) a backing layer or decorative layer adjacent to the reinforcing layers;
wherein the foam sheet is bonded to the reinforcing layers by an isocyanate functional composition according to claim 1;
wherein the article is useful as a headliner in a vehicle having an interior cabin.

20. An article according to claim 19 wherein one of the reinforcing layers is located adjacent to each of the faces of the foam sheet; one of the backing layers is located adjacent to each of the reinforcing layers, and the decorative layer is disposed adjacent to the backing layers adapted to be disposed facing the interior cabin of the automobile.
